(19) United States
(12) Patent Application Publication
(10) Pub. No.: US 2007/0184172 A1
(43) Pub. Date: Aug. 9, 2007

(54) METHOD OF FLAVORING HOT LIQUIDS

(76) Inventor: Lori Timmerman, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/275,917

(22) Filed: Feb. 3, 2006

(51) Int. Cl. A23F 5/00

(52) U.S. Cl. 426/594

(57) ABSTRACT

A delivery system for providing flavoring to a hot beverage, including a hot water soluble edible material having and a flavoring substance coupled to the material. When the material is placed into a beverage having a temperature of between about 130 and about 200 degrees Fahrenheit, the material dissolves without congealing and releases the flavoring substance into the beverage. The material is sized to accommodate sufficient flavoring substance to flavor a cup of coffee.

### TECHNICAL FIELD OF THE INVENTION

The invention relates generally to the field of refreshments and, specifically, to a method of flavoring hot drinks, such as coffee.

### BACKGROUND OF THE INVENTION

After oil, coffee is the worlds leading commodity with annual sales of about 70 billion dollars. The most recent annual harvest produced about 7 million tons of beans. Coffee beans are grown mostly in a narrow band of warm climates in Latin America, Africa and Asia. Higher quality beans, such as arabica beans, require higher altitudes, temperate climates and nutrient-rich soil, such as are found in volcanic slopes in Costa Rica. In the United States, Hawaii and Puerto Rico are the only locations with the proper climates suitable for the commercial production of grown coffee. As higher quality beans are more difficult to cultivate, the coffee market is dominated by lower-quality fare, such as unwashed arabica and robusta beans, which are combined to produce such commodity products as canned blends and instant coffees. Robustas grow in hotter, wetter, lower-altitude regions and yield more beans than arabica plants.

As low-grade coffee is in long supply, coffee connoisseurs must resort to adding flavorings to make their drinks more palatable. Further, even those fortunate enough to be drinking high-quality coffee sometimes prefer the addition of cream, sweetener, and/or exotic flavorings. Additionally, tea drinkers often face the same issues regarding flavoring inferior quality hot tea drinks. Typically, these flavorings come in the form of powders (such as sugar, sweeteners, non-diary creamers and some flavorings) or liquids (milk, cream, or syrups such as vanilla, hazelnut, and the like) to be added to the hot coffee. While helpful in achieving a better tasting coffee beverage, these additives have some inherent drawbacks.

Powdered additives typically come in small, individual packages and thus inherently produce waste packaging that must be disposed of after each use. Further, powdered additives are often difficult to dissolve, even in hot water/coffee. Finally, as coffee drinkers are frequently in transit from one place to another, mixing a drink from one or more prepackaged components may be cumbersome distracting, and lead to coffee spills, accidents, or worse.

Liquid additives present their own set of drawbacks. First, the liquids are usually syrups or dairy products, and as such contribute to sticky messes when spilled. Also, diary products have relatively short shelf lives and are prone to spoiling. Liquid additives may also be individually pre-packaged, yielding packaging waste similar to that described above, with the additional drawback of likely leakage and/or spillage when used. Liquid additives in bottles do not have as mush spill and waste packaging problems, but are instead bulky and inconvenient, especially for travelers.

Thus, there remains a need for an easily dissolved flavoring additive for coffee and other hot beverages that presents a reduced waste packaging, spill and mess risk than traditional powdered and liquid additives. The present invention addresses this need.

### SUMMARY OF THE INVENTION

The present invention relates to a delivery system and method for flavoring hot liquids. One object of the present invention is to provide an improved method of flavoring hot beverages. Related objects and advantages of the present invention will be apparent from the following description.

### BRIEF DESCRIPTION OF THE DRAWINGS

FIG. 1 is a perspective view of a first embodiment soluble flavor delivery strip of the present invention.

FIG. 2 is a partial cutaway view of strip of FIG. 1 being dissolved in a beverage.

FIG. 3 is a partial perspective view of the strip of FIG. 1 with recesses formed therein for containing various soluble flavorants.

FIG. 4 is a partial perspective view of a second embodiment soluble flavor delivery strip of the present invention FIG. 5B is a perspective view of a third embodiment soluble flavor delivery system of the present invention.

### DETAILED DESCRIPTION OF THE PREFERRED EMBODIMENTS

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

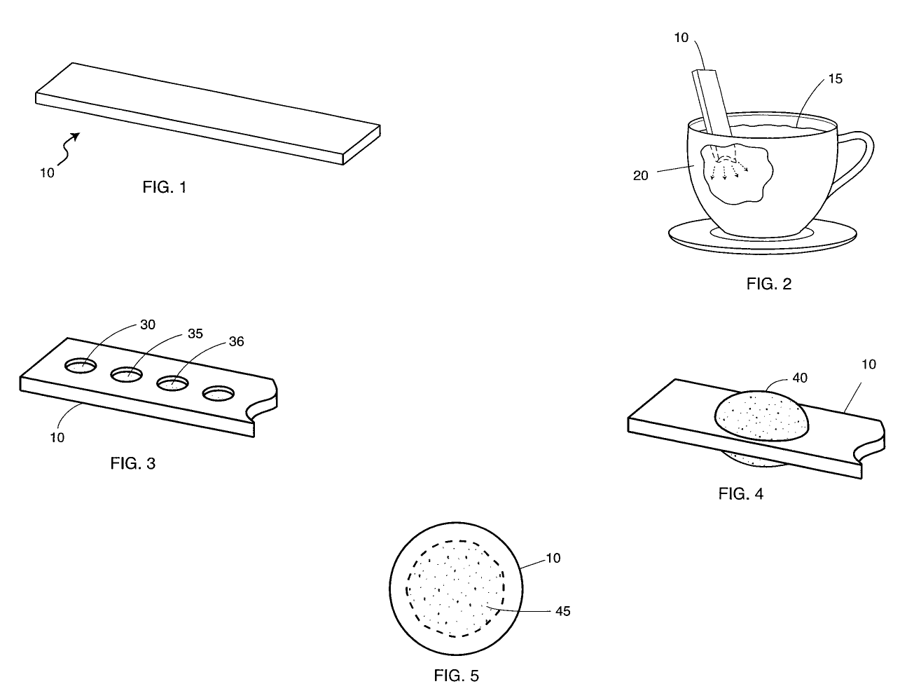

FIGS. 1-3 illustrate a first embodiment of the present invention, an edible, hot-water soluble delivery system 10 for introducing predetermined, measured amounts of flavoring into a hot beverage, such as coffee, tea, hot chocolate or the like. The delivery system 10 is typically a soluble thin member, such as a film or generally thin strip, and is made from a primary, film-forming component selected from the group consisting of pullulan, hydroxypropylmethyl cellulose, hydroxyethyl cellulose, hydroxypropyl cellulose, polyvinyl pyrrolidone, carboxymethyl cellulose, polyvinyl alcohol, sodium alginate, polyethylene glycol, xanthan gum, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, case in and mixtures thereof. Typically, the film/strip 10 is primarily composed of pullulan, in amounts ranging from about 30 to about 95 weight percent, more typically from about 45 to about 70 weight percent of the film/strip 10 and even more typically from about 60 to about 65 weight percent of the film/strip 10. Typically, the film/strip 10 has a composition that is readily and substantially completely soluble in hot water having a temperature of at least about 130 degrees Fahrenheit; more typically, the film/strip 10 is readily and substantially completely soluble in hot water having a temperature of at least about 150 degrees Fahrenheit; still more typically, the film/strip 10 is readily and substantially completely soluble in hot water having a temperature of at least about 170 degrees Fahrenheit; and yet more typically, the film/strip 10 is readily and substantially completely soluble in hot water having a temperature of at least about 190 degrees Fahrenheit. Such compositions have been recently developed by, and are available from, the Watson Food Company, Inc., of 301 Heffernan Drive, West Haven, Conn., 06516.

The hot water soluble edible thin member 10 typically includes flavoring agents such as artificial or natural sweeteners, artificial or natural creamers, essential oils (such as cinnamon, vanilla, hazelnut and the like), or the like in addition to the (typically pollulan) film-forming material. The flavoring agents may be integral to the composition of the member 10 or may be coated thereon. In addition, the hot water soluble edible thin member 10 can further include water, preservatives, antimicrobial agents, additional film-forming agents, plasticizing agents (such as triacetin, monoacetin, diacetin and the like), surfactants (such as mono and diglycerides of fatty acids and polyoxyethylene sorbitol esters and the like), stabilizing agents (such as xanthan gum, locust bean gum, carrageenan, guar gum, and the like), emulsifiers (such as triethanolamine stearate, quaternary ammonium compounds, acacia, gelatin, lecithin, bentonite, veegum, and the like), thickeners (such as methylcellulose, carboxyl methylcellulose, and the like), binders (such as starch), chromophores, and the like. Further, the surface may be imprinted with an edible ink, such as to convey information regarding the flavor contents of the strip, for decoration, or both.

It is anticipated that for some flavors a relatively high oil or flavorant content may be required to produce the desired taste effect when dissolved into a hot beverage. Typically, enough flavorant should be present to substantially flavor a cup of coffee (typically at least about eight ounces). Moreover, different flavorant or oil concentrations may be required to tailor the strips 10 for use with coffees or other beverages of different strengths. In these cases, it will be preferable to avoid substantial amounts of humectant in the hot water soluble edible thin member 10, and more preferable avoid humectant in the member 10 altogether, to avoid an overly moist, self-adhering (i.e., sticky and slimy) member 10. In particular, it is preferred to produce the member 10 without glycerin, a plasticizing agent that is also a humectant, as well as without sorbitol, a sugar alcohol sweetener that is also a mild humectant.

Suitable sweeteners that can be included are those well known in the art, including both natural and artificial sweeteners. These suitable sweeteners include, e.g.:
water-soluble sweetening agents such as monosaccharides, disaccharides and polysaccharides such as xylose, ribose, glucose (dextrose), mannose, galactose, fructose (levulose), sucrose (sugar), maltose, invert sugar (a mixture of fructose and glucose derived from sucrose), partially hydrolyzed starch, corn syrup solids, dihydrochalcones, monellin, steviosides, and glycyrrhizin;
water-soluble artificial sweeteners such as the soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (acesulfame-K), the free acid form of saccharin, and the like;
dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5,dihydrophenyl-glycine, L-aspartyl-2,5-dihydro-L-phenylalanine, L-aspartyl-L-(1-cyclohexyen)-alanine, and the like;
water-soluble sweeteners derived from naturally occurring water-soluble sweeteners, such as a chlorinated derivative of ordinary sugar (sucrose), known, for example, under the product description of sucralose; and
protein based sweeteners such as thaumatoccous danielli (Thaumatin I and II).
   In general, the amount of sweetener incorporated into or onto the thin member 10 will depend on its intended flavoring composition. For example, a creamer-flavored member 10 may have little to no sweetener, while a strip intended to deliver no other flavor than “sweet” may have the balance of its composition as after the film forming material as sweetener, typically around 35 weight percent and potentially as much as 70 weight percent or more. Other flavorings will require varying amounts of sweetener to provide a balance to provide the level of sweetness desired for a particular composition, and this amount will vary with flavor, the concentration of the essential oils, and the composition of the sweetener selected. This amount will normally be between about 1 percent and about 30 percent by weight of the composition when using an easily extractable sweetener.

The flavorings that can be used include those known to the skilled artisan, such as natural and artificial flavors. These flavorings may be chosen from synthetic flavor oils and flavoring aromatics, and/or oils, oleo resins and extracts derived from plants, leaves, flowers, fruits and so forth, and combinations thereof. Representative flavor oils include: cinnamon oil, hazelnut oil, cocoa oil, peppermint oil, oil of nutmeg, oil of sage, and oil of bitter almonds. Also useful are artificial, natural or synthetic fruit flavors such as vanilla, chocolate, coffee, cocoa and citrus oil, including lemon and orange, grapefruit and fruit essences including apple, peach, strawberry, raspberry, and so forth. These flavorings can be used individually or in admixture. Commonly used flavors include mints such as peppermint, artificial vanilla, cinnamon derivatives, and various fruit flavors, whether employed individually or in admixture. Flavorings such as aldehydes and esters including cinnamyl acetate, cinnamaldehyde, citral, diethylacetal, dihydrocarvyl acetate, eugenyl formate, p-methylanisole, and so forth may also be used. Generally, any flavoring or food additive, such as those described in Chemicals Used in Food Processing, publication 1274 by the National Academy of Sciences, pages 63-258, may be used. Further examples of aldehyde flavorings common to flavoring coffee and or tea include include, but are not limited to acetaldehyde (apple); benzaldehyde (cherry, almond); cinnamic aldehyde (cinnamon); citral, i.e., alpha citral (lemon, lime); neral, i.e. beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde (butter); valeraldehyde (butter); citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2-6-dimethyloctanal (green fruit); and 2-dodecenal (citrus, mandarin); cherry; grape; mixtures thereof; and the like.

The amount of flavoring employed is normally a matter of preference subject to such factors as flavor type, individual flavor, and strength desired. Thus, the amount may be varied in order to obtain the result desired in the final product. Such variations are within the capabilities of those skilled in the art without the need for undue experimentation. In general, amounts of about 0.1 to about 30 weight percent are useable with amounts of about 2 to about 25 weight percent being preferred and amounts from about 8 to about 10 weight percent are more preferred.

The compositions of this invention can also contain coloring agents or colorants. The coloring agents are used in amounts effective to produce the desired color. The useful coloring agents include pigments such as titanium dioxide, which may be incorporated in amounts of up to about 5 weight percent, and typically less than about 1 weight percent. Colorants can also include natural food colors and dyes suitable for food, drug and cosmetic applications. These colorants are known as FD&C dyes and lakes. The materials acceptable for the foregoing spectrum of use are typically water-soluble, and include FD&C Blue No. 2, which is the disodium salt of 5,5-indigotindisulfonic acid. Similarly, the dye known as Green No. 3 comprises a triphenylmethane dye and is the monosodium salt of 4-[4-N-ethyl-p-sulfobenzylamino) diphenyl-methylene]-[1-N-ethyl-N-p-sulfonium benzyl)-2,5-cyclo-hexadienimine].

FIG. 2 illustrates the soluble flavored member 10 as introduced into a beverage 15. The member 10 dissolves 20 into the beverage 15, thereby introducing concentrated flavorant into the beverage. The member 10 typically has a thickness of about 0.1 mm, and more typically of about 0.2 mm. Still more typically, the member has a thickness of 1 millimeter or less. FIG. 3 illustrates the member 10 including a plurality of pockets or recesses 30 formed therein, typically on the side to be coated or filled with flavorant 35, 36. Each recess 30 may be filled or coated with a different flavorant 35, 36, such as in solid, powdered or gelled form. Upon introduction into a beverage 15, the member 10 and the flavorants 35, 36 simultaneously dissolve, again releasing flavor into the beverage 15. The advantage of the recesses 30 is that different combinations of flavors may be added to a base member 10 that may be manufactured with a common base flavor, such as vanilla, or no flavor at all, thus enabling mass production of members 10 that may later be flavored as desired.

FIG. 4 illustrates a second embodiment of the invention, a generally thin soluble member 10 with a pouch or cavity 40 formed therein for filling with a solid, powdered, gelled or liquid flavorant. The member 10 may be formed unflavored or with an inherent flavor, and a complementary flavoring may fill the cavity 40. Alternately, the cavity 40 may be filled with the base beverage flavor, such as coffee or tea, while the member 10 includes the complementary flavor, such as hazelnut or vanilla.

FIG. 5 illustrates yet another embodiment of the present invention, a spherical ball 45 of a first soluble flavorant wrapped in a soluble film 10 that may optionally be flavored with a second complementary flavorant. As above, the film 10 quickly dissolves in the beverage, resulting in the beverage contacting and then dissolving the inner ball 45 of flavorant. The inner ball 45 may be a powder, solid, gel, liquid or the like.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A method of flavoring hot beverages, comprising:
a. applying a flavoring substance onto a strip of water soluble edible material; and
b. dissolving the strip of water soluble edible material with the flavoring substance thereon into a hot beverage;
wherein the beverage has a temperature of at least about 130 degrees Fahrenheit;
wherein the strip of water soluble edible material substantially completely dissolves into the hot beverage without congealing or agglomerating.

2. The method of claim 1 wherein the flavoring substance is a sweetener.

3. The method of claim 1 wherein the flavoring substance is a non-dairy creamer.

4. The method of claim 1 wherein the strip of material is a piece of high density polyethylene film having a nominal film thickness of about 0.1 mm.

5. The method of claim 1 wherein the strip of water soluble edible material is substantially flat and rectangular in shape with rounded corners, wherein the strip of water soluble edible material including the flavoring substance applied thereon has an overall thickness less than about 1 mm.

6. The method of claim 1 wherein the flavoring substance is encapsulated by the strip of water soluble edible material.

7. The method of claim 1 wherein the beverage is coffee.

8. The method of claim 1 wherein the beverage has a temperature of at least about 190 degrees Fahrenheit.

9. A method of flavoring a hot beverage, said method comprising the steps of:
a. integrating a flavoring substance into a flexible strip of edible water soluble material; and
b. dissolving the flexible strip of edible water soluble material into a hot beverage;
wherein the flexible strip is sized to accept sufficient flavoring to flavor at least about one cup of hot beverage.

10. The method of claim 9 wherein the beverage is coffee and wherein the flavoring substance is selected from the group containing creamer, sweetener, hazlenut essence, vanilla essence, and combinations thereof.

11. The method of claim 9 wherein the flexible strip of edible water soluble material is a piece of high density polyethylene film having a nominal film thickness of at least about 0.2 mm.

12. The method of claim 9 wherein the flexible strip of edible water soluble material includes an internal pouch formed therein and wherein the pouch contains a water soluble flavoring powder.

13. The method of claim 12 wherein the flavoring powder is instant coffee.

14. A delivery system for providing flavoring to a hot beverage, comprising:
a hot-water soluble edible material; and
a flavoring substance coupled to the material such that when the material is placed into a beverage having a temperature of between about 130 and about 200 degrees Fahrenheit, the material dissolves without congealing and releases the flavoring substance into the beverage;
wherein the material is sized to accommodate sufficient flavoring substance to flavor a cup of coffee.

15. The delivery system of claim 14 wherein the flavoring substance is a sweetener and sufficient flavoring substance is coupled to the strip to provide the equivalent of one teaspoon of sugar to the beverage.

16. The delivery system of claim 14 wherein the flavoring substance is a creamer and sufficient flavoring substance is coupled to the strip to provide the equivalent of one ounce of cream to the beverage.

17. The delivery system of claim 14 wherein the flavoring substance is a substantially uniform continuous coating on the material.

18. The delivery system of claim 17 wherein the material is formed into a thin strip with shallow pockets on a first substance-coated side of said strip of material, the shallow pockets having the flavoring substance located therein.

19. The delivery system of claim 14 wherein the material is a piece of high density polyethylene film having a nominal film thickness of at least about 0.2 mm.

20. The delivery system of claim 14 wherein the material is substantially flat and rectangular in shape with rounded corners, the strip of hot water soluble edible material including the flavoring substance applied thereon having an overall thickness less than about 1 mm.

21. The delivery system of claim 14 wherein the material is formed into a hollow sphere and wherein the flavoring substance substantially fills the hollow sphere.
